(19) United States
(12) Patent Application Publication
(10) Pub. No.: US 2006/0012719 A1
(43) Pub. Date: Jan. 19, 2006

(54) System and method for motion prediction in scalable video coding

(75) Inventors: Marta Karczewicz, Irving, TX (US); Xianglin Wang, Irving, TX (US); Yiliang Bao, Irving, TX (US); Justin Ridge, Irving, TX (US)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 10/891,430

(22) Filed: Jul. 14, 2004

Related U.S. Application Data
(60) Provisional application No. 60/587,415, filed on Jul. 12, 2004.

(51) Int. Cl. H04B 1/66; H04N 5/14

(52) U.S. Cl. 348/699; 375/240.16

(57) ABSTRACT

A device, system and method for motion vector prediction in scalable video coding. Embodiments of the present invention may determine a predictive motion vector in scalable video coding by obtaining current layer motion vectors; determining a final base layer motion vector; and calculating a predictive motion vector based on the current layer motion vectors and the final base layer motion vector. A similarity or consistency of neighboring motion vectors at a current layer and a reliability of motion vector prediction using neighboring motion vectors at a base layer may be used to determine the predictive motion vector.

### CROSS REFERENCE TO RELATED APPLICATION

The present application claims priority to provisional application No. 60/______, entitled “System And Method For Motion Prediction In Scalable Video Coding,” filed Jul. 12, 2004, the contents of which are hereby incorporated by reference herein.

### FIELD OF THE INVENTION

Embodiments of the present invention relate to the field of video coding and, in particular, to systems and methods for motion prediction in scalable video coding.

### BACKGROUND

Digital video is typically compressed to facilitate storage and broadcasting. Compressed video can be stored in a smaller space and can be transmitted with less bandwidth than the original, uncompressed video content, thereby easing storage and transmission requirements.

Digital video consists of sequential images that are displayed at a constant rate (30 images/second, for example). A common way of compressing digital video is to exploit redundancy between these sequential images, e.g., temporal or spatial redundancy. Since consecutive images in a video sequence may have very much the same content, it can be advantageous to transmit only differences between consecutive images. A difference frame, which may be referred to as a prediction error frame Eₙ, may be defined as the difference between the current frame Iₙ and the reference frame Pₙ, one of the previously coded frames. The prediction error frame is thus
Eₙ(x,y)=Iₙ(x,y)−Pₙ(x,y).

where n is the frame number and (x, y) represents pixel coordinates. In a typical video codec, the difference frame is compressed before transmission. Compression may be achieved by Discrete Cosine Transform (DCT), Huffman coding or similar methods.

Since video to be compressed contains motion, subtracting two consecutive images does not always result in the smallest difference. For example, when a camera is panning, the whole scene is changing. To compensate for this motion, a displacement (Δx(x, y), Δy(x, y)), typically referred to as a motion vector, is added to the coordinates of the previous frame. Thus, the prediction error becomes
Eₙx,y)=Iₙ(x,y)−Pₙ(x+Δx(x, y), y+Δy(x, y)).

Any pixel of the previous frame can be subtracted from the pixel in the current frame; thus, the resulting prediction error is smaller. However, having a motion vector for every pixel is generally not practical because the motion vector then has to be transmitted for every pixel. Consequently, one motion vector generally represents a number of contiguous pixels commonly referred to as a “block” of pixels.

### SUMMARY

According to embodiments of the present invention, a method for motion vector prediction in scalable video coding may include identifying a current block in a current layer; obtaining neighboring motion vectors corresponding to blocks neighboring the current block in the current layer; determining a final base layer motion vector; calculating a predictive motion vector based on the neighboring motion vectors or the final base layer motion vector. The method may further include identifying the neighboring motion vectors or the final base layer motion vector for a predictive motion vector calculation Identifying may include determining a consistency of neighboring motion vectors at a current layer; and determining a reliability of motion vector prediction. Identifying may further include analyzing the neighboring motion vectors at a base layer.

The method may further include obtaining a reference frame index corresponding to each neighboring motion vector in the current layer; comparing the reference frame index of the neighboring motion vectors to a reference frame index of a current block; and using the current layer motion vectors having the same reference index as the current block to calculate the predictive motion vector. The method may further include comparing a reference frame index of the final base layer motion vector to a reference frame index of a current block; and using the final base layer motion vector to calculate the predictive motion vector if the reference frame index of the final base layer motion vector is the same as the reference frame index of the current block.

Calculating a predictive motion vector may further include calculating the predictive motion vector using a combination of the neighboring motion vectors at the current layer and the final base layer motion vector. Determining a consistency of neighboring motion vectors may include calculating a vector distance. Determining a final base layer motion vector may include determining whether a number of co-located base layer motion vectors for a current block is equal to one or greater than one; selecting a single co-located base layer motion vector as the final base layer motion vector when the number of co-located base layer motion vectors for a current block is equal to one; performing an arithmetic operation on the co-located base layer motion vectors when the number of co-located base layer motion vectors for a current block is greater than one; and selecting the result of the arithmetic operation as the final base layer motion vector.

The arithmetic operation may be an average of the co-located base layer motion vectors or a median of the co-located base layer motion vectors. Performing the arithmetic operation on the co-located base layer motion vectors may include obtaining reference frame indexes of the co-located base layer motion vectors; comparing the reference frame indexes of the co-located base layer motion vectors to a reference frame index of a current block; and performing the arithmetic operation on only the co-located base layer motion vectors having the same reference frame index as the current block. Averaging may include weighting the co-located base layer motion vectors according to a block size of the co-located base layer motion vectors. Calculating a median may include weighting the co-located base layer motion vectors according to a block size of the co-located base layer motion vectors.

The method may further include generating a signal indicating whether the neighboring motion vectors or the final base layer motion vectors are used in calculating the predictive motion vector. Generating a signal may include generating a signal using arithmetic coding. A context selection for the arithmetic coding may be based on a consistency of the neighboring motion vectors at the current layer. A context selection for the arithmetic coding may depend on a reliability of motion vector prediction. The reliability of motion vector prediction may utilize the neighboring motion vectors from a base layer.

A method for decoding a predictive motion vector in scalable video coding may include receiving a signal indicating use of a final base layer motion vector and neighboring motion vectors in a current layer in generating the predictive motion vector; computing the predictive motion vector; and determining the motion vector for a current block from the predictive motion vector based on the final base layer motion vector and the neighboring motion vectors. Use of the neighboring motion vectors is based on a consistency of the neighboring motion vectors and on a reliability of motion vector prediction using neighboring motion vectors at a base layer.

According to an embodiment of the present invention, a device for motion vector prediction in scalable video coding may include a storage element for storing current layer motion vectors; and a processor configured to determine a final base layer motion vector; and calculate a predictive motion vector based on the current layer motion vectors and the final base layer motion vector. Use of the current layer motion vectors to calculate the predictive motion vector may be based on a consistency of neighboring motion vectors at a current layer; and a reliability of motion vector prediction using neighboring motion vectors at a base layer. The processor may determine a consistency of neighboring motion vectors by calculating a vector distance.

According to an embodiment of the present invention, a device for decoding a predictive motion vector in scalable video coding may include a storage element for storing a predictive motion vector; a receiving element for receiving a signal indicating use of a final base layer motion vector and current layer motion vectors in generating the predictive motion vector; and a processor coupled to the receiving element, the processor configured to determine a motion vector for a current block from the predictive motion vector using the final base layer motion vector and the current layer motion vectors. The the storage element may further store a consistency of neighboring motion vectors at a current layer, and a reliability of motion vector prediction using neighboring motion vectors at a base layer.

According to an embodiment of the present invention, a system for motion vector prediction encoding and decoding in scalable video coding may include a receiving unit for receiving current layer motion vectors and co-located base layer motion vectors; and a processing unit configured to determine a final base layer motion vector using the co-located base layer motion vectors; and calculate a predictive motion vector based on current layer motion vectors and a final base layer motion vector. The receiving unit and the processing unit may be disposed on a mobile device. The mobile device may be a mobile telephone.

According to an embodiment of the present invention, a computer program product may include a computer useable medium having computer program logic recorded thereon for enabling a processor to generate a predictive motion vector for scalable video coding, where the computer program logic may include an obtaining procedure enabling the processor to obtain neighboring motion vectors at a current layer; a first determining procedure enabling the processor to determine a final base layer motion vector; and a calculating procedure enabling the processor to calculate a predictive motion vector based on the neighboring motion vectors and the final base layer motion vector. Use of the neighboring motion vectors to calculate the predictive motion vector may be based on a consistency of neighboring motion vectors at a current layer; and a reliability of motion vector prediction using neighboring motion vectors at a base layer.

According to an embodiment of the present invention, a computer program product may include a computer useable medium having computer program logic recorded thereon for enabling a processor to decode a predictive motion vector in scalable video coding, where the computer program logic may include a first receiving procedure enabling the processor to receive a signal indicating use of a final base layer motion vector and current layer motion vectors in generating the predictive motion vector; and a determining procedure enabling the processor to determine a motion vector for a current block from the predictive motion vector based on the final base layer motion vector and the current layer motion vectors.

According to an embodiment of the present invention, a method for determining a final base layer motion vector may include determining whether a number of co-located base layer motion vectors for a current block is equal to one or greater than one; selecting a single co-located base layer motion vector as the final base layer motion vector when the number of co-located base layer motion vectors for a current block is equal to one; performing an arithmetic operation on the co-located base layer motion vectors when the number of co-located base layer motion vectors for a current block is greater than one; and selecting as result of the arithmetic operation as the final base layer motion vector. The arithmetic operation may be an average of the co-located base layer motion vectors or a median of the co-located base layer motion vectors. Performing the arithmetic operation on the co-located base layer motion vectors may include obtaining reference frame indexes of the co-located base layer motion vectors; comparing the reference frame indexes of the co-located base layer motion vectors to a reference frame index of a current block; and performing the arithmetic operation on only the co-located base layer motion vectors having the same reference frame index as the current block.

### BRIEF DESCRIPTION OF THE DRAWINGS

A detailed description of embodiments of the invention will be made with reference to the accompanying drawings, wherein like numerals designate corresponding parts in the several figures.

FIG. 1 shows an example system in which embodiments of the present invention may be utilized according to an embodiment of the present invention.

FIG. 2 is a block diagram of an example video encoder in which embodiments of the present invention may be implemented according to an embodiment of the present invention.

FIG. 3 is a block diagram of an example video decoder in which embodiments of the present invention may be implemented according to an embodiment of the present invention.

FIG. 4A shows an example of a macroblock on a base layer and corresponding temporal or quality enhancement layer with mode 16×16 according to an embodiment of the present invention.

FIG. 4B shows an example of a macroblock on a base layer and corresponding temporal or quality enhancement layer with mode 8×16 according to an embodiment of the present invention.

FIG. 4C shows an example of a macroblock on a base layer and corresponding spatial enhancement layer with mode 16×16 according to an embodiment of the present invention.

FIG. 4D shows an example of a macroblock on a base layer and corresponding spatial enhancement layer with mode 16×8 according to an embodiment of the present invention.

FIG. 5 shows a generalized flow diagram for calculating a predictive motion vector according to an embodiment of the present invention

FIG. 6 shows a generalized flow diagram for determining a final base layer motion vector from co-located motion vectors according to an embodiment of the present invention.

### DETAILED DESCRIPTION OF EXEMPLARY EMBODIMENTS

In the following description of preferred embodiments, reference is made to the accompanying drawings which form a part hereof, and in which is shown by way of illustration specific embodiments in which the invention may be practiced. It is to be understood that other embodiments may be utilized and structural changes may be made without departing from the scope of the preferred embodiments of the present invention.

In scalable video coding, a current layer may be an enhancement in spatial resolution, temporal resolution or picture quality. In the discussion below, the term “base layer” may be an absolute base layer that is generated by a non-scalable codec, such as is defined in the H.264 standard, or an enhancement layer that is used as a basis for encoding a current enhancement layer. In addition, in the discussion below, when a motion vector from a spatial base layer is to be used, it is assumed that motion vector up-sampling has been performed.

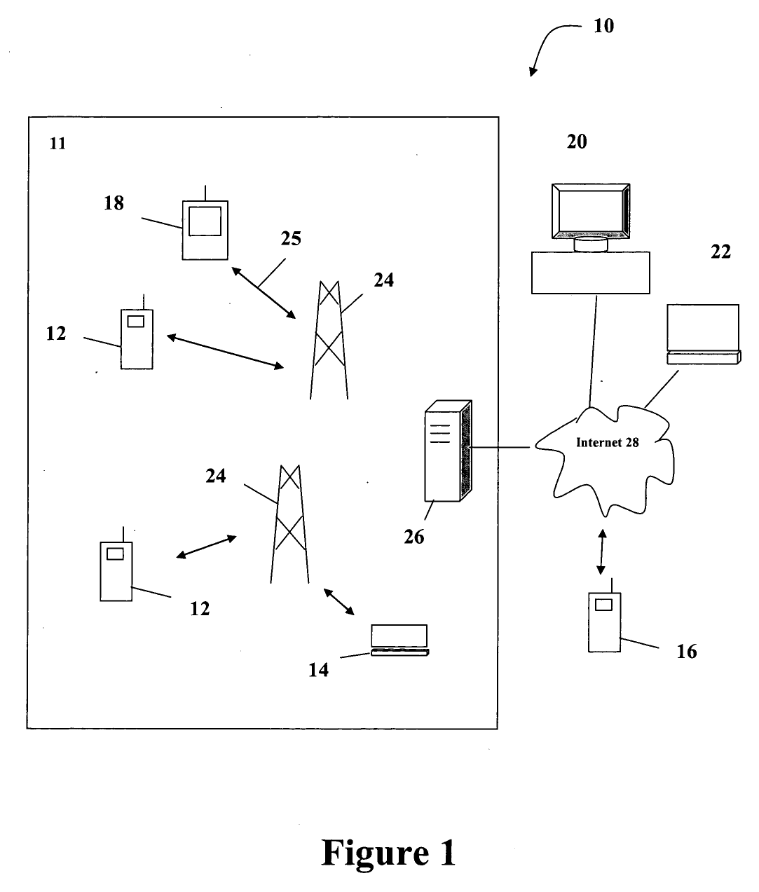

Embodiments of the present invention may be used in a variety of applications, environments, systems and the like. For example, FIG. 1 shows an example system 10 in which embodiments of the present invention may be utilized. The system 10 shown in FIG. 1 may include multiple communication devices that can communicate through a network, such as cellular or mobile telephones 12 and 14, for example. The system 10 may include any combination of wired or wireless networks including, but not limited to, a cellular telephone network, a wireless Local Area Network (LAN), a Bluetooth personal area network, an Ethernet LAN, a token ring LAN, a wide area network, the Internet and the like. The system 10 may include both wired and wireless communication devices.

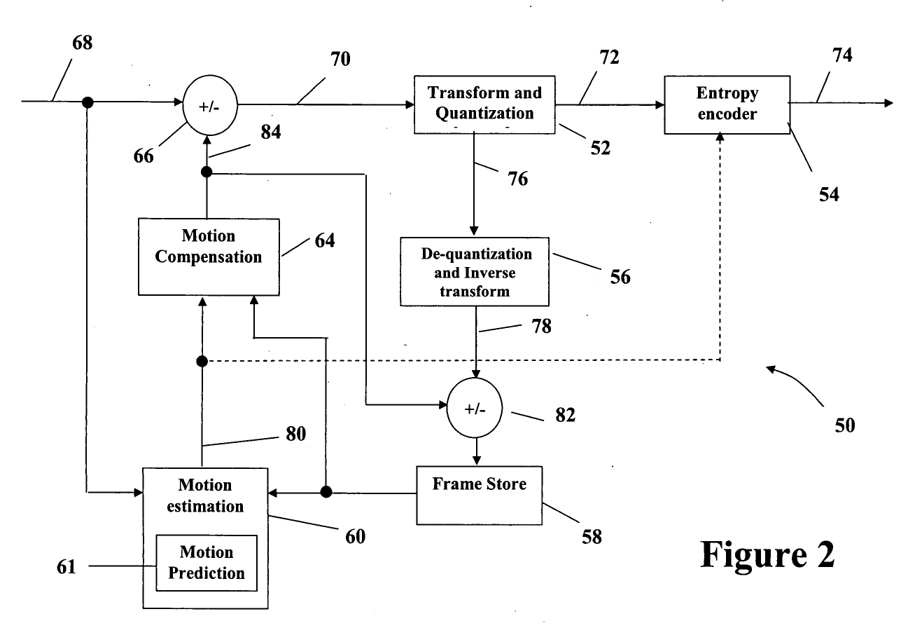

FIG. 2 is a block diagram of an example video encoder 50 in which embodiments of the present invention may be implemented. As shown in FIG. 2, the encoder 50 receives input signals 68 indicating an original frame and provides signals 74 indicating encoded video data to a transmission channel (not shown). The encoder 50 may include a motion estimation block 60 to carry out motion estimation across multiple layers and generate a set of predications. Resulting motion data 80 is passed to a motion compensation block 64. The motion compensation block 64 may form a predicted image 84. As the predicted image 84 is subtracted from the original frame by a combining module 66, the residuals 70 are provided to a transform and quantization block 52 which performs transformation and quantization to reduce the magnitude of the data and sends the quantized data 72 to a de-quantization and inverse transform block 56 and an entropy coder 54. A reconstructed frame is formed by combining the output from the de-quantization and inverse transform block 56 and the motion compensation block 64 through a combiner 82. After reconstruction, the reconstructed frame may be sent to a frame store 58. The entropy encoder 54 encodes the residual as well as motion data 80 into encoded video data 74.

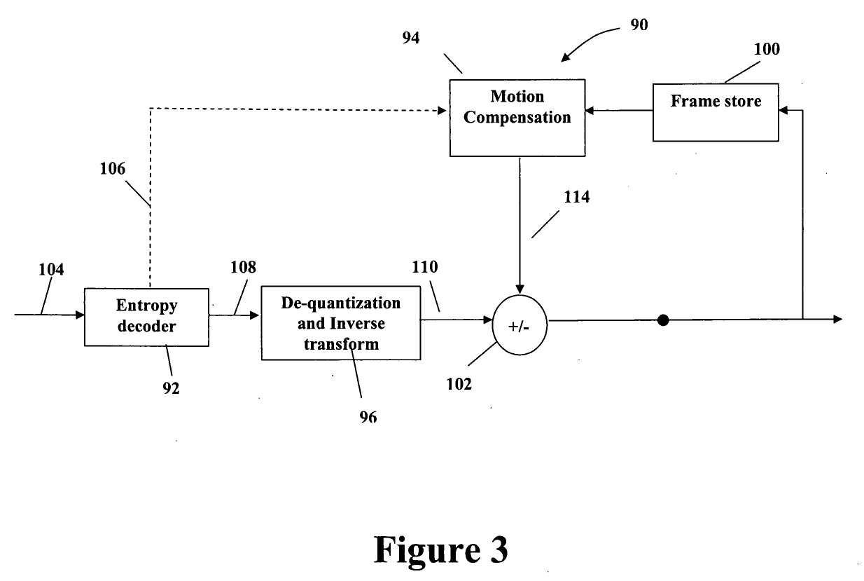

FIG. 3 is a block diagram of an example video decoder 90 in which embodiments of the present invention may be implemented. In FIG. 3, a decoder 90 may use an entropy decoder 92 to decode video data 104 from a transmission channel into decoded quantized data 108. Motion data 106 is also sent from the entropy decoder 92 to a de-quantization and inverse transform block 96. The de-quantization and inverse transform block 96 may then convert the quantized data into residuals 110. Motion data 106 from the entropy decoder 92 is sent to the motion compensation block 94 to form predicted images 114. With the predicted image 114 from the motion compensation block 94 and the residuals 110 from the de-quantization and inverse transform block 96, a combination module 102 may provide signals 118 that indicate a reconstructed video image.

According to embodiments of the present invention, when there are multiple co-located motion vectors available at a base layer for a current block, all such motion vectors may be taken into consideration when determining a base layer motion vector, hereinafter called a final base layer motion vector (FBLM vector), that is to be used for a current block motion prediction.

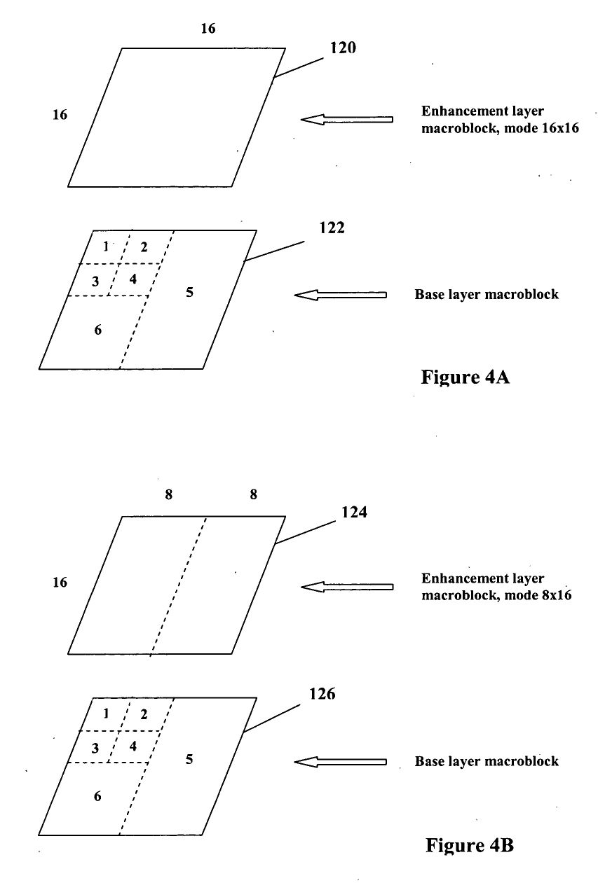

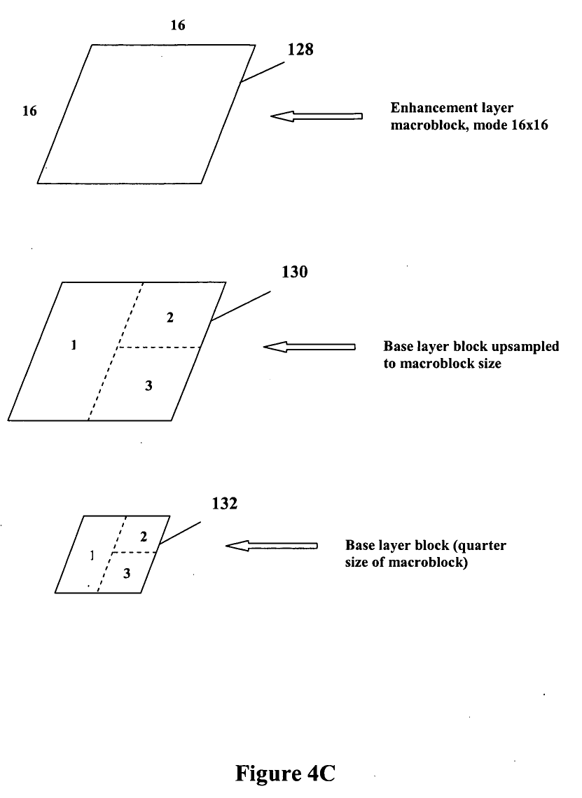

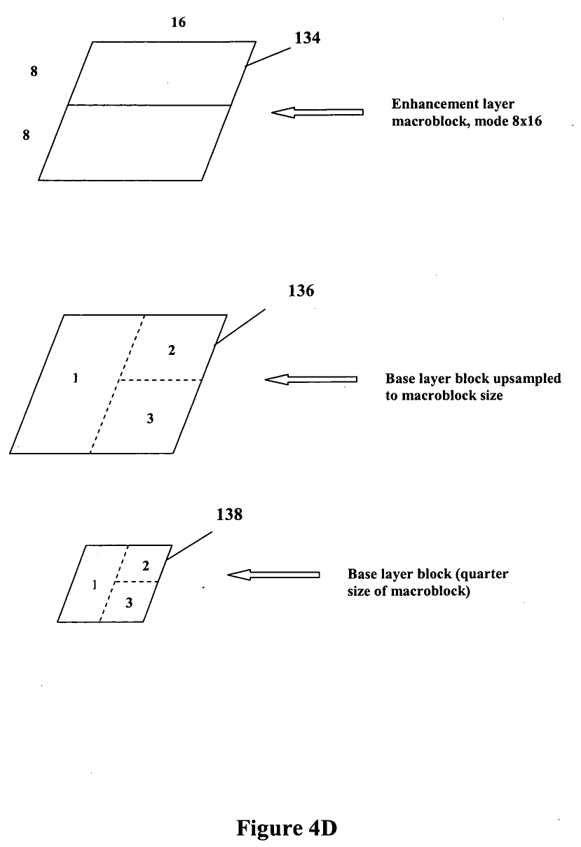

When a current layer is a temporal resolution or picture quality enhancement layer, each macroblock on the current layer has a same-size corresponding macroblock on the base layer. In this case, depending on the block partition mode of the macroblock on the current layer, there may be multiple co-located motion vectors available at the base layer. For example, in FIG. 4A, if the block partition mode in the enhancement layer macroblock 120 is 16×16, all six motion vectors corresponding to the six blocks shown in the base layer macroblock 122 are considered co-located motion vectors for the current 16×16 block 120. Similarly, if the block partition mode in the enhancement layer macroblock 124 is 8×16 as shown in FIG. 4B, then the left 8×16 block has five co-located motion vectors from the base layer macroblock 126 and the right 8×16 block has one co-located motion vector from the base layer macroblock 126.

When the current block is a spatial resolution enhancement layer, each macroblock on the current layer may correspond to, for example, a quarter size area in a macroblock on the base layer. In this case, the quarter size macroblock area on the base layer may be upsampled to macroblock size and the corresponding motion vectors up-scaled by two as well. Depending on the block partition mode of the macroblock on the current layer, there may also be multiple co-located motion vectors available at the base layer. For example, as shown in FIG. 4C, if the block partition mode is 16×16 for the enhancement layer macroblock 130, all three motion vectors corresponding to the three blocks shown in the base layer 132 are considered co-located motion vectors for the current 16×16 block 130. Likewise, if the block partition mode is 16×8, as shown in FIG. 4D, then the upper 16×8 block of the enhancement layer macroblock 136 has two co-located motion vectors from the base layer 138, one from block 1 and the other from block 2. The lower 16×8 block of the enhancement layer macroblock 136 also has two co-located motion vectors from the base layer 138, one from block 1 and the other from block 3.

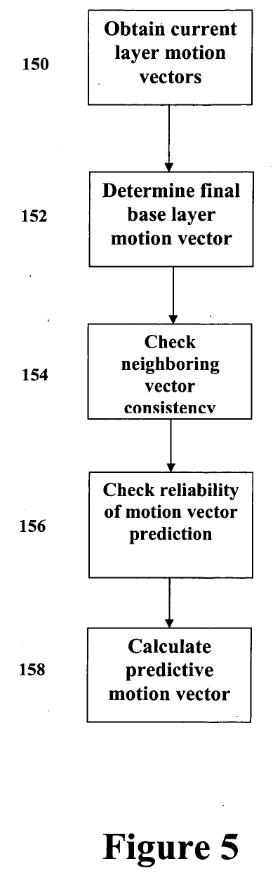

FIG. 5 shows a generalized flow diagram for calculating a predictive motion vector according to an embodiment of the present invention. At step 150, current layer motion vectors for a current block are obtained.

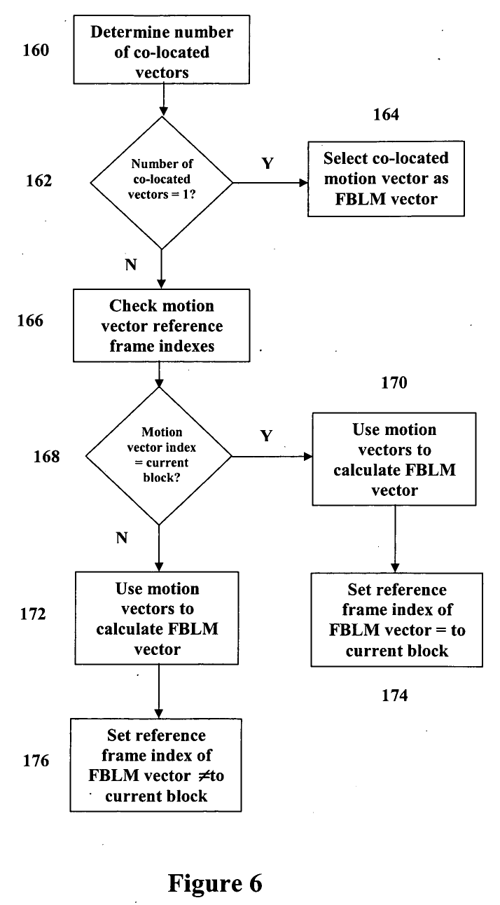

At step 152, a final base layer motion vector is determined. FIG. 6 shows a generalized flow diagram for determining a final base layer motion vector from co-located motion vectors according to an embodiment of the present invention. Referring to FIG. 6, at step 160, the number of co-located vectors available from a base layer for a current block at the enhancement layer is determined. At step 162, if there is only one co-located motion vector available from the base layer for the current block at the enhancement layer, that motion vector is selected as the final base layer motion vector at step 164.

Otherwise, at step 162, if there are multiple co-located motion vectors available from the base layer for the current block, their reference frame indexes may be checked at step 166. Each motion vector may have a reference frame index associated with it. The reference frame index indicates the frame number of the reference frame that this motion vector is referring to. Priority is given to motion vectors with the same reference frame index as the current block being encoded. Thus, at step 168, if the co-located motion vectors available on the base layer have the same reference frame index as the current block, then at step 170 these motion vectors are used to calculate the final base layer motion vector. According to embodiments of the present invention, the final base layer motion vector may be calculated in a variety of ways using these motion vectors. For example, an average of the vectors with the same reference frame index as the current block can be taken as the final base layer motion vector. As another example, a median may also be used in calculating the final base layer motion vector from these multiple co-located motion vectors with the same reference frame index as the current block. At step 174, the reference frame index of the final base layer motion vector may be set to the same value as the current block.

Returning back to step 168, if none of the co-located motion vectors available on the base layer have the same reference frame index as the current block, then at step 172 these motion vectors are used to calculate the final base layer motion vector. As before, the final base layer motion vector may be calculated in a variety of ways using these motion vectors, such as, for example, using an average or a median of these motion vectors. At step 176, the reference frame index of the final base layer motion vector may be set to a value different than that of the current block.

According to embodiments of the present invention, when calculating the average or median of multiple co-located base layer motion vectors, the block partition size of a motion vector may be taken into consideration. For example, motion vectors with a larger block size could be given greater weight in a calculation. For example, referring back to FIG. 4A, if all six motion vectors, (Δx₁, Δy₁), (Δx₂, Δy₂), . . . , (Δx₆, Δy₆) corresponding to each block, are used to calculate a final base layer motion vector, motion vector (Δx₅, Δy₅) could be given eight times the weight as those in blocks 1, 2, 3 and 4. Similarly, motion vector (Δx₆, Δy₆) could be given four times the weight as those in blocks 1, 2, 3 and 4.

Referring back to FIG. 5, the similarity or consistency of the neighboring motion vectors may be checked at the current layer at step 154 to determine whether use of the current layer motion vectors may be used to calculate the predictive motion vector. When neighboring motion vectors are similar to each other, they are considered to be better candidates to be used for motion vector prediction. Checking the similarity or consistency of the neighboring motion vectors may be done in a variety of ways. For example, according to an embodiment of the present invention, vector distance may be used as a measure of similarity or consistency of the neighboring motion vectors. As an example, let the predictive motion vector obtained using motion vectors (Δx₁, Δy₁), (Δx₂, Δy₂), . . . , (Δxₙ, Δyₙ) be denoted by (Δxₚ, Δyₚ). A measure of consistency may be defined as the sum of the square differences between these vectors (Δx₁, Δy₁), (Δx₂, Δy₂), . . . , (Δxₙ, Δyₙ) and the predictive motion vector (Δxₚ, Δyₚ).

At step 156, the reliability of motion vector prediction using neighboring vectors at a base layer may be checked to indicate whether use of the current layer motion vectors to calculate the predictive motion vector is reliable. The reliability of motion vector prediction may be checked in a variety of ways. For example, according to an embodiment of the present invention the reliability of motion vector prediction may be measured as a difference (delta vector) between the predictive motion vector and the coded motion vector for the co-located block in the base layer. If the predictive motion vector calculated using neighboring vectors at the base layer is not accurate for the base layer, it may be likely that the predictive motion vector calculated using neighboring vectors will also not be accurate for the current layer.

Referring again back to FIG. 5, at step 158, the predictive motion vector may now be determined. The predictive motion vector may be calculated from either the current layer motion vectors or the final base layer motion vector or as a combination of these two.

According to an embodiment of the present invention, when neighboring motion vectors at a current layer and the final base layer motion vector are both available for calculating the predictive motion vector and if only one of them has the same reference frame index as the current block, the vector with the same reference frame index as the current block could be given a greater weight or higher priority and should be selected as the predictive motion vector. Otherwise, the predictive motion vector may be determined by choosing the motion vector with the greater weight or higher priority based on the similarity or consistency of the neighboring motion vectors at the current layer and the reliability of motion vector prediction at the base layer.

In addition, the selection of current motion vectors or the final base layer motion vector to calculate predictive motion vectors may be signaled to a decoder using, for example, arithmetic coding. In this case, context may be dependent a consistency of neighboring motion vectors at a current layer and a reliability of motion vector prediction using neighboring motion vectors at a base layer.

Thus, using embodiments of the present invention, a predictive motion vector may be adaptively calculated. The overhead required for encoding flag bits indicating a layer from which a motion vector is selected is, therefore, eliminated or reduced. Coding performance is, thereby, improved.

While particular embodiments of the present invention have been shown and described, it will be obvious to those skilled in the art that the invention is not limited to the particular embodiments shown and described and that changes and modifications may be made without departing from the spirit and scope of the appended claims.

What is claimed is:

1. A method for motion vector prediction in scalable video coding comprising:
identifying a current block in a current layer;
obtaining neighboring motion vectors corresponding to blocks neighboring the current block in the current layer;
determining a final base layer motion vector;
calculating a predictive motion vector based on the neighboring motion vectors or the final base layer motion vector.

2. The method of claim 1, further comprising identifying the neighboring motion vectors or the final base layer motion vector for a predictive motion vector calculation, wherein identifying includes:
determining a consistency of neighboring motion vectors at a current layer; and
determining a reliability of motion vector prediction.

3. The method of claim 1, further comprising:
obtaining a reference frame index corresponding to each neighboring motion vector in the current layer;
comparing the reference frame index of the neighboring motion vectors to a reference frame index of a current block; and
using the current layer motion vectors having the same reference index as the current block to calculate the predictive motion vector.

4. The method of claim 1, further comprising:
comparing a reference frame index of the final base layer motion vector to a reference frame index of a current block; and
using the final base layer motion vector to calculate the predictive motion vector if the reference frame index of the final base layer motion vector is the same as the reference frame index of the current block.

5. The method of claim 1, wherein calculating a predictive motion vector further comprises calculating the predictive motion vector using a combination of the neighboring motion vectors at the current layer and the final base layer motion vector.

6. The method of claim 5, wherein determining a consistency of neighboring motion vectors comprises calculating a vector distance.

7. The method of claim 1, wherein determining a final base layer motion vector comprises:
determining whether a number of co-located base layer motion vectors for a current block is equal to one or greater than one;
selecting a single co-located base layer motion vector as the final base layer motion vector when the number of co-located base layer motion vectors for a current block is equal to one;
performing an arithmetic operation on the co-located base layer motion vectors when the number of co-located base layer motion vectors for a current block is greater than one; and
selecting the result of the arithmetic operation as the final base layer motion vector.

8. The method of claim 7, wherein the arithmetic operation is an average of the co-located base layer motion vectors.

9. The method of claim 7, wherein the arithmetic operation is a median of the co-located base layer motion vectors.

10. The method of claim 9, wherein performing the arithmetic operation on the co-located base layer motion vectors comprises:
obtaining reference frame indexes of the co-located base layer motion vectors;
comparing the reference frame indexes of the co-located base layer motion vectors to a reference frame index of a current block; and
performing the arithmetic operation on only the co-located base layer motion vectors having the same reference frame index as the current block.

11. The method of claim 9, wherein averaging comprises weighting the co-located base layer motion vectors according to a block size of the co-located base layer motion vectors.

12. The method of claim 10, wherein calculating a median comprises weighting the co-located base layer motion vectors according to a block size of the co-located base layer motion vectors.

13. The method of claim 1, further comprising generating a signal indicating whether the neighboring motion vectors or the final base layer motion vectors are used in calculating the predictive motion vector.

14. The method of claim 13, wherein generating a signal includes generating a signal using arithmetic coding.

15. The method of claim 14, wherein a context selection for the arithmetic coding is based on a consistency of the neighboring motion vectors at the current layer.

16. The method of claim 14, wherein a context selection for the arithmetic coding depends on a reliability of motion vector prediction.

17. The method of claim 16, wherein the reliability of motion vector prediction utilizes the neighboring motion vectors from a base layer.

18. The method of claim 2, wherein identifying further includes analyzing the neighboring motion vectors at a base layer.

19. A method for decoding a predictive motion vector in scalable video coding comprising:
receiving a signal indicating use of a final base layer motion vector and neighboring motion vectors in a current layer in generating the predictive motion vector;
computing the predictive motion vector; and
determining the motion vector for a current block from the predictive motion vector based on the final base layer motion vector and the neighboring motion vectors.

20. The method of claim 19, wherein use of the neighboring motion vectors is based on a consistency of the neighboring motion vectors and on a reliability of motion vector prediction using neighboring motion vectors at a base layer.

21. A device for motion vector prediction in scalable video coding comprising:
a storage element for storing current layer motion vectors; and
a processor configured to
determine a final base layer motion vector; and
calculate a predictive motion vector based on the current layer motion vectors and the final base layer motion vector,
wherein use of the current layer motion vectors to calculate the predictive motion vector is based on
a consistency of neighboring motion vectors at a current layer; and
a reliability of motion vector prediction using neighboring motion vectors at a base layer.

22. The device of claim 21, wherein the processor determines a consistency of neighboring motion vectors by calculating a vector distance.

23. A device for decoding a predictive motion vector in scalable video coding comprising:
a storage element for storing a predictive motion vector;
a receiving element for receiving a signal indicating use of a final base layer motion vector and current layer motion vectors in generating the predictive motion vector; and
a processor coupled to the receiving element, the processor configured to determine a motion vector for a current block from the predictive motion vector using the final base layer motion vector and the current layer motion vectors.

24. The device of claim 23, wherein the storage element further stores
a consistency of neighboring motion vectors at a current layer, and
a reliability of motion vector prediction using neighboring motion vectors at a base layer.

25. A system for motion vector prediction encoding and decoding in scalable video coding comprising:
a receiving unit for receiving current layer motion vectors and co-located base layer motion vectors; and
a processing unit configured to
determine a final base layer motion vector using the co-located base layer motion vectors; and
calculate a predictive motion vector based on current layer motion vectors and a final base layer motion vector.

26. The system of claim 25, wherein the receiving unit and the processing unit are disposed on a mobile device.

27. The system of claim 26, wherein the mobile device is a mobile telephone.

28. A computer program product comprising a computer useable medium having computer program logic recorded thereon for enabling a processor to generate a predictive motion vector for scalable video coding, the computer program logic comprising:
an obtaining procedure enabling the processor to obtain neighboring motion vectors at a current layer;
a first determining procedure enabling the processor to determine a final base layer motion vector; and
a calculating procedure enabling the processor to calculate a predictive motion vector based on the neighboring motion vectors and the final base layer motion vector,
wherein use of the neighboring motion vectors to calculate the predictive motion vector is based on
a consistency of neighboring motion vectors at a current layer; and
a reliability of motion vector prediction using neighboring motion vectors at a base layer.

29. A computer program product comprising a computer useable medium having computer program logic recorded thereon for enabling a processor to decode a predictive motion vector in scalable video coding, the computer program logic comprising:
a first receiving procedure enabling the processor to receive a signal indicating use of a final base layer motion vector and current layer motion vectors in generating the predictive motion vector; and
a determining procedure enabling the processor to determine a motion vector for a current block from the predictive motion vector based on the final base layer motion vector and the current layer motion vectors.

30. A network element for motion vector prediction in scalable video coding comprising:
means for identifying a current block in a current layer;
means for obtaining neighboring motion vectors corresponding to blocks neighboring the current block in the current layer
means for determining a final base layer motion vector; and
means for calculating a predictive motion vector based on the neighboring motion vectors or the final base layer motion vector.

31. The network element of claim 30, further comprising means for identifying the neighboring motion vectors or the final base layer motion vector for a predictive motion vector calculation, wherein the means for identifying includes:
means for determining a consistency of neighboring motion vectors at a current layer; and
means for determining a reliability of motion vector prediction.

32. A method for determining a final base layer motion vector comprising:
determining whether a number of co-located base layer motion vectors for a current block is equal to one or greater than one;
selecting a single co-located base layer motion vector as the final base layer motion vector when the number of co-located base layer motion vectors for a current block is equal to one;
performing an arithmetic operation on the co-located base layer motion vectors when the number of co-located base layer motion vectors for a current block is greater than one; and
selecting as result of the arithmetic operation as the final base layer motion vector.

33. The method of claim 32, wherein the arithmetic operation is an average of the co-located base layer motion vectors.

34. The method of claim 32, wherein the arithmetic operation is a median of the co-located base layer motion vectors.

35. The method of claim 34, wherein performing the arithmetic operation on the co-located base layer motion vectors comprises:
obtaining reference frame indexes of the co-located base layer motion vectors;
comparing the reference frame indexes of the co-located base layer motion vectors to a reference frame index of a current block; and
performing the arithmetic operation on only the co-located base layer motion vectors having the same reference frame index as the current block.
